(19) United States
(12) Patent Application Publication
(10) Pub. No.: US 2026/0326457 A1
(43) Pub. Date: Oct. 22, 2026

(54) INKJET RECORDING APPARATUS

(71) Applicant: KYOCERA Document Solutions Inc., Osaka (JP)

(72) Inventors: Nobuhiro MAEZAWA, Osaka (JP); Akifumi NABE, Osaka (JP)

(73) Assignee: KYOCERA Document Solutions Inc., Osaka (JP)

(21) Appl. No.: 19/638,905

(22) Filed: Apr. 3, 2026

(30) Foreign Application Priority Data
Apr. 18, 2025 (JP) 2025-068545

(51) Int. Cl. B41J 11/00; B41J 3/407; C09D 11/38; C09D 11/54

(52) U.S. Cl. CPC B41J 11/0015; B41J 3/407; C09D 11/38; C09D 11/54

(57) ABSTRACT

An inkjet recording apparatus includes a conveyance portion, a recording portion, and an application portion. The conveyance portion conveys a recording medium. The recording portion includes a recording head that ejects aqueous ink onto the recording medium conveyed thereto by the conveyance portion. The application portion is arranged upstream of the recording portion in a conveyance direction of the recording medium and applies a pretreatment liquid to the recording medium while wiping off an excess of the pretreatment liquid therefrom. The pretreatment liquid is a polyhydric alcohol having 4 to 6 carbon atoms or a monoether of the polyhydric alcohol.

### INCORPORATION BY REFERENCE

This application is based upon and claims the benefit of priority from the corresponding Japanese Patent Application No. 2025-068545 (filed on Apr. 18, 2025), the entire contents of which are hereby incorporated by reference.

### BACKGROUND

The present disclosure relates to an inkjet recording apparatus that ejects ink onto a recording medium to record an image thereon.

As recording apparatuses such as facsimiles, copy machines, and printers, inkjet recording apparatuses that eject ink to record images are widely used since they are capable of forming high-definition images.

In such an inkjet recording apparatus, it has become mainstream to use aqueous pigment ink that uses a pigment having excellent weatherability as a colorant. The aqueous pigment ink, however, has presented a problem that repelling or feathering of the ink is likely to occur when the ink is ejected onto a recording medium having low wettability, such as a plastic sheet.

### SUMMARY

An inkjet recording apparatus according to one aspect of the present disclosure includes a conveyance portion, a recording portion, and an application portion. The conveyance portion conveys a recording medium. The recording portion includes a recording head that ejects aqueous ink onto the recording medium conveyed thereto by the conveyance portion. The application portion is arranged upstream of the recording portion in a conveyance direction of the recording medium and applies a pretreatment liquid to the recording medium while wiping off an excess of the pretreatment liquid therefrom. The pretreatment liquid is a polyhydric alcohol having 4 to 6 carbon atoms or a monoether of the polyhydric alcohol.

### BRIEF DESCRIPTION OF THE DRAWINGS

FIG. 1 is a schematic view showing a structure of an inkjet recording apparatus according to one embodiment of the present disclosure.

FIG. 2 is an enlarged view of and around a recording portion and an application portion shown in FIG. 1.

FIG. 3 is a view showing another configuration example of the application portion.

FIG. 4 is a view showing an image of one-dot lines printed using aqueous ink at 600 dpi on a sheet to which a pretreatment liquid has not been applied.

FIG. 5 is a view showing an image of one-dot lines printed using the aqueous ink at 600 dpi on a sheet to which the pretreatment liquid has been applied.

FIG. 6 is a view schematically showing a state of ink droplets immediately after landing on a sheet and a state thereof after being dried in a case where the pretreatment liquid has not been applied to the sheet.

FIG. 7 is a view schematically showing a state of ink droplets immediately after landing on a sheet and a state thereof after being dried in a case where the pretreatment liquid has been applied to the sheet.

### DETAILED DESCRIPTION

### [1. Pretreatment Liquid]

A pretreatment liquid used in an inkjet recording apparatus of the present disclosure is used, when the inkjet recording apparatus forms an image using aqueous ink that contains a pigment dispersion containing a pigment and a resin, an organic solvent, and water, to adjust wettability of a plastic sheet as a recording medium so as to suppress repelling or feathering of the ink. The following describes in detail the pretreatment liquid used in the inkjet recording apparatus of the present disclosure.

As the pretreatment liquid, a polyhydric alcohol or a polyhydric alcohol monoether is used. The polyhydric alcohol or the polyhydric alcohol monoether has an appropriate degree of affinity (hydrophilicity) for aqueous ink and an appropriate degree of affinity (hydrophobicity) for a plastic sheet as a recording medium. It is, therefore, possible to impart, when the recording medium has a low surface tension, an appropriate degree of wettability to the recording medium so that the surface tension thereof is increased and thus to suppress repelling of ink droplets.

Here, in a case where the polyhydric alcohol has 3 or less carbon atoms, the pretreatment liquid completely evaporates before ink droplets are ejected. On the other hand, in a case where the polyhydric alcohol has 7 or more carbon atoms, the pretreatment liquid dries insufficiently, and this necessitates a mechanism for drying the pretreatment liquid to be separately provided. For this reason, in this embodiment, as the pretreatment liquid, there is used a polyhydric alcohol having 4 to 6 carbon atoms or a polyhydric alcohol monoether obtained by substituting one of hydroxyl groups of the polyhydric alcohol having 4 to 6 carbon atoms with an ether group.

Specific examples of the polyhydric alcohol having 4 to 6 carbon atoms include glycols such as diethylene glycol, dipropylene glycol, and triethylene glycol, dihydric alcohols such as 1,4-butanediol, 1,4-butenediol, 1,5-pentanediol, and 1,6-hexanediol, and trihydric alcohols such as 2-hydroxy-1,4-butanediol, 2-hydroxy-3-methyl-1,4-butanediol, 2-hydroxy-1,5-pentanediol, trimethylolethane, and trimethylolpropane. Any two or more of these compounds may be used in combination.

Specific examples of the polyhydric alcohol monoether include glycol monoethers such as diethylene glycol monomethyl ether, diethylene glycol monoethyl ether, dipropylene glycol monomethyl ether, dipropylene glycol monoethyl ether, triethylene glycol monomethyl ether, and triethylene glycol monoethyl ether, monoethers of dihydric alcohols such as 4-methoxybutanol, 5-methoxypentanol, and 6-methoxyhexanol, and monoethers of trihydric alcohols such as 5-methoxy-1,2-pentanediol. Any two or more of these compounds may be used in combination.

Among the above-described examples of the polyhydric alcohol having 4 to 6 carbon atoms and the polyhydric alcohol monoether, particularly preferable are dipropylene glycol and dipropylene glycol monomethyl ether.

### [2. Image Recording Method]

Next, a description is given of an image recording method using an inkjet recording apparatus. The inkjet recording apparatus used in the image recording method of the present disclosure is not particularly limited, and an inkjet recording apparatus of a serial head type or a line head type is used thereas. While, particularly in an inkjet recording apparatus using aqueous pigment ink, repelling or feathering of the ink is likely to occur when a plastic sheet is used as a recording medium, according to the image recording method of the present disclosure, such a problem is unlikely to occur.

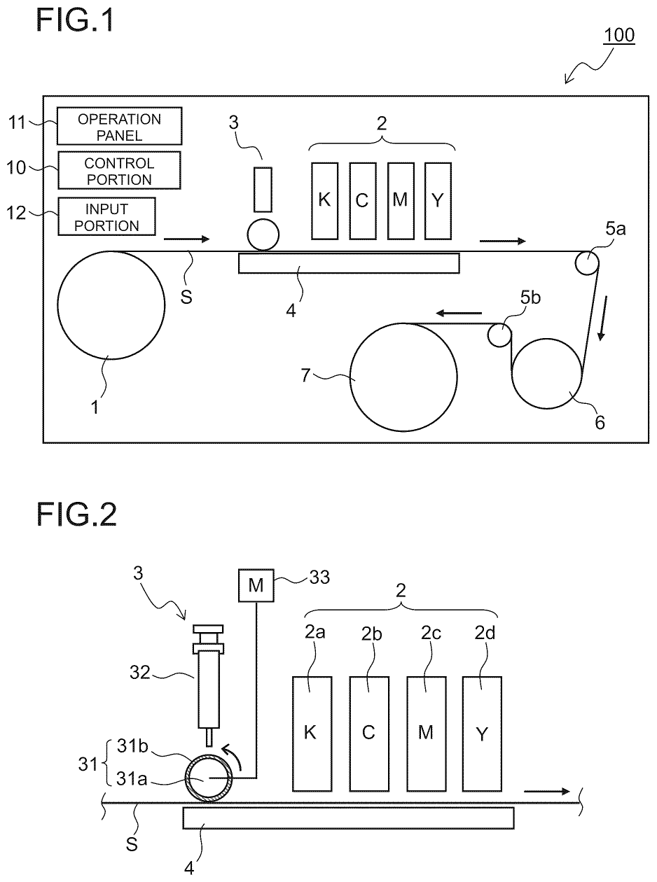

FIG. 1 is a schematic view showing a structure of an inkjet recording apparatus 100 according to one embodiment of the present disclosure. FIG. 2 is an enlarged view of and around a recording portion 2 and an application portion 3 shown in FIG. 1. As shown in FIG. 1, the inkjet recording apparatus 100 includes a sheet feed-out portion 1, the recording portion 2, the application portion 3, a conveyance plate 4, a heating drum 6, a sheet winding portion 7, a control portion 10, an operation panel 11, and an input portion 12.

A sheet S, which is an elongated printing base material (herein, a plastic sheet), is placed in the sheet feed-out portion 1 provided upstream of the recording portion 2 in a conveyance direction (on a left side in FIG. 1). The sheet feed-out portion 1 includes a rotary shaft on which the sheet S wound in a roll shape is mounted and a motor for driving the rotary shaft to rotate in a prescribed rotational direction (neither of them is shown). The sheet S is fed out downstream in the conveyance direction (to a right side in FIG. 1) as the rotary shaft rotates through driving of the motor. Arrows in FIG. 1 each indicate a moving direction of the sheet S.

The recording portion 2 includes recording heads 2a, 2b, 2c, and 2d (see FIG. 2). The recording heads 2a to 2d are supplied respectively with ink of four different colors (yellow, magenta, cyan, and black) stored in ink tanks (not shown). Using the recording heads 2a to 2d, the recording portion 2 records an image on the sheet S fed out from the sheet feed-out portion 1.

The application portion 3 is arranged upstream of the recording portion 2 in a sheet conveyance direction (on the left side in FIG. 1). As shown in FIG. 2, the application portion 3 includes an application roller 31, a syringe (liquid supply mechanism) 32, and a roller drive motor 33.

The application roller 31 is arranged to be in contact with an entire region of the sheet S in a width direction thereof. The application roller 31 includes a roller body 31a and a fiber layer 31b. The roller body 31a is an elastic roller formed of a metal core and an elastic layer stacked on an outer circumferential surface of the metal core (neither of them is shown).

The fiber layer 31b is wound on an outer circumferential surface of the roller body 31a. While the fiber layer 31b may be a woven fabric or a nonwoven fabric, when the fiber layer 31b is made of a fuzzy fiber material, fiber waste detached from the fiber layer 31b might adhere to the sheet S and adversely affect image quality. For this reason, preferably, the fiber layer 31b is made of a material unlikely to generate fuzz.

Directly above the application roller 31, a plurality of syringes 32 are arranged along the width direction of the sheet S (a direction perpendicular to a drawing plane of FIG. 2). By the syringes 32, the earlier described pretreatment liquid is applied dropwise to the application roller 31. The pretreatment liquid may be supplied to the application roller 31 by a method different from using the syringes 32. Examples of such a method include inkjet ejection of the pretreatment liquid.

By the roller drive motor 33, the application roller 31 is driven to rotate in a forward direction (a counterclockwise direction in FIG. 2) with respect to the moving direction of the sheet S at a speed substantially equal to a moving speed of the sheet S. Thus, the application roller 31 applies the earlier described pretreatment liquid to a surface of the sheet S while wiping off an excess of the pretreatment liquid therefrom. As a result, a film of the pretreatment liquid so thin as to be visually unrecognizable is formed on the surface of the sheet S.

The conveyance plate 4 is arranged below the recording portion 2 and the application portion 3. By the conveyance plate 4, the sheet S fed out from the sheet feed-out portion 1 is supported at a prescribed distance from the recording portion 2 and the application portion 3.

The sheet S that has passed through the recording portion 2, after its conveyance direction is changed by a guide roller 5a, is conveyed to the heating drum 6. When the sheet S contacts the heating drum 6, the ink on the sheet S is dried and fixed to the sheet S. The sheet S to which the ink has been fixed, after its conveyance direction is changed by a guide roller 5b, is wound in a roll shape at the sheet winding portion 7. While in this embodiment, the heating drum 6 is used to dry the ink, any other drying device such as a halogen heater, an infrared dryer, or a hot air dryer may be used.

In accordance with image data received from an external computer, the control portion 10 controls ink ejection at the recording portion 2. Furthermore, as will be described later, in accordance with the image data, the control portion 10 determines an ejection target region to which the pretreatment liquid is to be ejected at the application portion 3.

The operation panel 11 functions as a touch panel for a user to perform various types of settings for the inkjet recording apparatus 100 and inputting thereto, and displays a state of the inkjet recording apparatus 100, an image recording status, the number of sheets printed, and so on.

The input portion 12 receives image data from an external apparatus such as a personal computer. Based on the image data received at the input portion 12, the control portion 10 controls ink ejection onto the sheet S by the recording portion 2 so that a prescribed image is recorded on the sheet S. In a case where the inkjet recording apparatus 100 has an image reading function (a scanner function), an image reading portion also functions as the input portion 12.

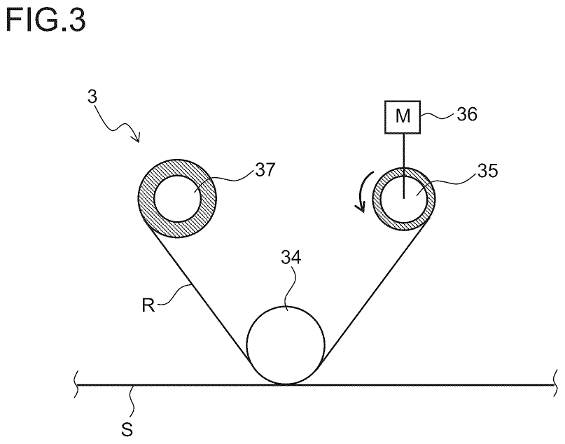

The application portion 3 is not limited to a configuration shown in FIG. 2 and may have a configuration shown in FIG. 3. An application portion 3 shown in FIG. 3 includes a pressing roller (pressing member) 34, a fabric winding roller 35, a winding motor 36, and a fabric feed-out roller 37.

In a state of not rotating, the pressing roller 34 is pressed against the sheet S via a fabric R that has been impregnated with the pretreatment liquid. Thus, the pretreatment liquid with which the fabric R has been impregnated is applied to the surface of the sheet S, while an excess of the pretreatment liquid is wiped off therefrom by the fabric R. As the pressing roller 34, there is used an elastic roller including an elastic layer formed on a surface thereof. Instead of the pressing roller 34, for example, a pressing pad formed of an elastic material may be used.

By the winding motor 36, the fabric winding roller 35 is driven to rotate counterclockwise in FIG. 3. After the fabric R has been pressed against the sheet S for a given period of time by the pressing roller 34, the fabric winding roller 35 is rotated for a prescribed amount so that the fabric R is wound by a given length. This causes the fabric R that has previously been impregnated with the pretreatment liquid to be fed by a given length from the fabric feed-out roller 37. In this manner, the fabric R containing the pretreatment liquid is constantly pressed against the sheet S.

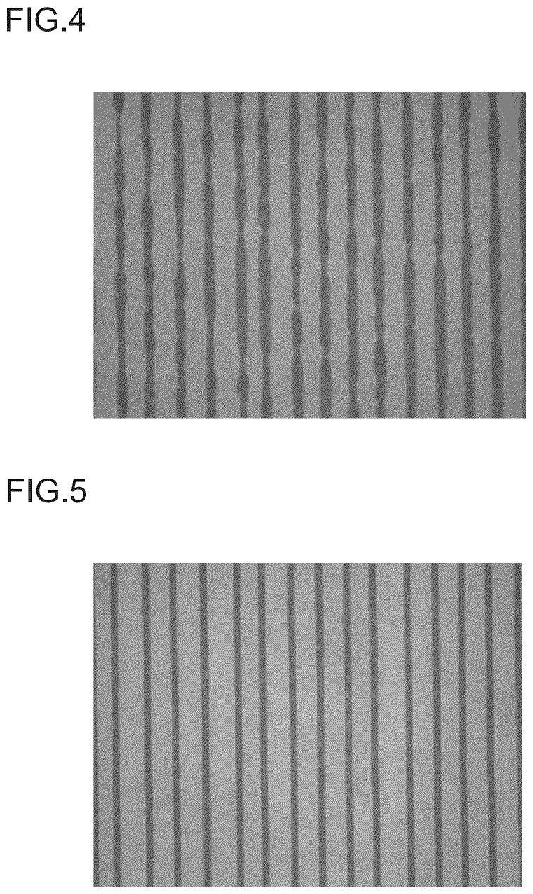

FIG. 4 is a view showing an image of one-dot lines printed using aqueous ink at 600 dpi on the sheet S to which the pretreatment liquid has not been applied. FIG. 5 is a view showing an image of one-dot lines printed using the aqueous ink at 600 dpi on the sheet S to which the pretreatment liquid has been applied.

As shown in FIG. 4, in a case where the pretreatment liquid has not been applied to the sheet S, resulting lines were partly thick and partly thin, i.e., nonuniform in line width. On the other hand, as shown in FIG. 5, in a case where the pretreatment liquid has been applied to the sheet S, resulting lines were uniform in line width.

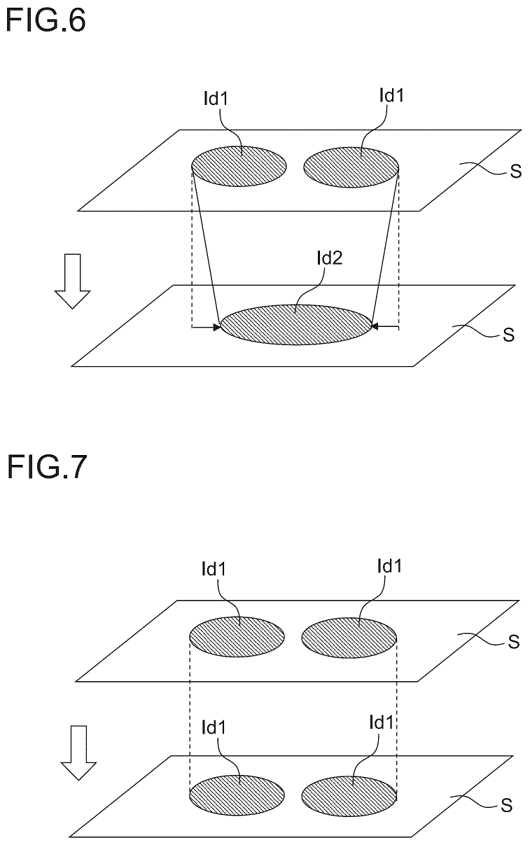

FIG. 6 and FIG. 7 are respectively views schematically showing a state of ink droplets immediately after landing on the sheet S and a state thereof after being dried in the case where the pretreatment liquid has not been applied to the sheet S and in the case where the pretreatment liquid has been applied to the sheet S. As shown in FIG. 6, in the case where the pretreatment liquid has not been applied to the sheet S and thus the sheet S has a low wetting tension, some adjacently ejected ink droplets Id1 might be attracted to each other to form (coalesce into) a single large ink droplet Id2. Resulting ink droplets are, therefore, nonuniform in size and also in line width as shown in FIG. 4.

On the other hand, as shown in FIG. 7, in the case where the pretreatment liquid has been applied to the sheet S, the sheet S has a high wetting tension, and thus coalescence of the ink droplets Id1 does not occur, causing no variation in size of resulting ink droplets. The resulting ink droplets are, therefore, uniform in line width as shown in FIG. 5. In a case where a plastic sheet as described above is used as the sheet S, by applying the pretreatment liquid thereto, it is possible to adjust the wetting tension of the sheet S to be in an optimum range so as to suppress feathering or repelling of the ink, thus improving printing performance.

Furthermore, depending on the wetting tension of the sheet S, the control portion 10 determines whether or not to apply the pretreatment liquid at the application portion 3 and an amount of the pretreatment liquid to be applied. Specifically, a table storing types of the sheet S in association with corresponding values of a surface tension (the wetting tension) thereof is previously stored in a storage portion (not shown). Further, at a start of printing, a type of the sheet S to be used is inputted via the operation panel 11 of the inkjet recording apparatus 100. The control portion 10 reads, from the table stored in the storage portion, a value of the surface tension corresponding to the inputted type of the sheet S and, based on the read value of the surface tension, determines whether or not to apply the pretreatment liquid at the application portion 3 and the amount of the pretreatment liquid to be applied.

This makes it possible to adjust the wetting tension of the sheet S to be in an optimum range so as to suppress feathering or repelling of the ink, thus obtaining good images. Furthermore, the pretreatment liquid is not applied to the sheet S when the sheet S has a high wetting tension, and thus it is also possible to suppress unnecessary consumption of the pretreatment liquid.

When the sheet S has a surface tension of not more than 40 mN/m, preferably, the pretreatment liquid is applied to the sheet S at the application portion 3. Furthermore, preferably, the lower the surface tension of the sheet S is, the higher the amount of the pretreatment liquid to be applied is.

According to the image recording method thus described, using the inkjet recording apparatus 100, to a sheet before being subjected to image formation using aqueous pigment ink, a polyhydric alcohol having 4 to 6 carbon atoms or a polyhydric alcohol monoether is applied as the pretreatment liquid, while an excess of the pretreatment liquid is wiped off therefrom. Thus, it is possible to increase wettability (a wetting tension) of the sheet so as to suppress repelling or feathering of the aqueous ink, thus improving image quality.

Furthermore, since a polyhydric alcohol having 4 to 6 carbon atoms or a polyhydric alcohol monoether is used as the pretreatment liquid, and an excess of the pretreatment liquid is wiped off at the application portion 3, a film of the pretreatment liquid so thin as to be visually unrecognizable can be formed on the surface of the sheet S. Thus, compared with a conventional configuration of applying a pretreatment liquid containing water, a binder resin, and so on, an amount of time required to dry the pretreatment liquid is reduced, so that there is no need for a drying portion for drying the pretreatment liquid to be provided upstream of the recording portion 2. The image recording method of the present disclosure is, therefore, favorably usable in various types of inkjet recording apparatuses using aqueous ink.

In addition, the present disclosure is not limited to the foregoing embodiment and can be variously modified within the scope of the claims. For example, while there has been described, with reference to FIG. 1, the inkjet recording apparatus 100 that feeds out an elongated sheet wound in a roll shape at a prescribed speed and ejects ink thereonto, the present disclosure is similarly applicable also to an inkjet recording apparatus that ejects ink onto a sheet cut in a prescribed shape.

Furthermore, a material of the recording medium is also not limited to a plastic film, and there can be used various types of recording media including paper such as plain paper or coated paper, a fabric such as a woven fabric, a knitted fabric, or a nonwoven fabric of natural or synthetic fibers, and so on. While the following more specifically describes effects of the present disclosure by way of examples, the present disclosure is not restricted to the examples.

### EXAMPLES

### Production Example 1

### (Preparation of Pigment Dispersion)

With 775 g of ion-exchanged water, 75 g of a pigment dispersion resin (DISPERBYK-190 manufactured by BYK Japan KK, nonvolatile content: 40% by mass, dispersion medium: water) was diluted, and 150 g of a pigment (Pigment Blue 15:03) was added thereto, after which a resulting mixture was preliminarily mixed using a homogenizing disperser at a rotational speed of 5000 rpm for an hour. After that, the mixture was subjected to a dispersion treatment using a bead mill (manufactured by Nippon Coke & Engineering Co., Ltd.), and thus a pigment dispersion was obtained. In this case, zirconia beads (0.2 mmq) were filled in a vessel at a filling ratio of 80% with respect to a capacity of the vessel. Resulting dispersed particles had a Z-average diameter of 101 nm.

### Production Example 2

### (Preparation of Ink)

Pigment ink was prepared by mixing 5% by mass of the pigment dispersion obtained in Production Example 1, 3% by mass of an urethane resin (HA560 manufactured by Nicca Chemical Co., Ltd.), 0.05% by mass of a surfactant (SAG-502A manufactured by Nissin Chemical Industry Co., Ltd.), 25% by mass of propylene glycol, 8% by mass of butyl triglycol, and 58.95% by mass of water.

### [Evaluation of Line Width Uniformity]

An evaluation was performed of line width uniformity in a case where image formation was performed using the pigment ink (cyan ink) obtained in Production Example 2. An OPP (biaxially stretched polypropylene) film having a width of 110 mm was used as a printing medium, and a conveyance speed of the printing medium was set to 100 m/min. Further, the pretreatment liquid was applied to the printing medium, while an excess of the pretreatment liquid was wiped off therefrom by pressing a wiping cloth (TX1008 manufactured by Texwipe) against the printing medium under a pressure of 1 N/m². After that, the printing medium was subjected to printing of one-dot lines at 600 dpi and then was dried using a hot air dryer at 80° C. for 120 seconds to give a printed matter. The printed matter thus obtained was observed using a microscope, and an evaluation of line width uniformity was performed based on evaluation criteria below.

### (Evaluation Criteria)

G: Resulting lines are uniform in line width.
P: Resulting lines are nonuniform in line width.

Table 1 shows results of the evaluation of line width uniformity along with types of the pretreatment liquid and values of a surface tension of the printing medium to which the pretreatment liquid has been applied.

TABLE 1

| | Pretreatment | Surface Tension | Line Width |
|---|---|---|---|
| | Liquid | [N/m] | Uniformity |
| Disclosure Example 1 | DPGME | 48 | G |
| Disclosure Example 2 | BTG | 44 | G |
| Comparative Example 1 | None | 30 | P |
| Comparative Example 2 | Water | 31 | P |

DPGME: dipropylene glycol monomethyl ether
BTG: butyl triglycol (dipropylene glycol)

As is apparent from Table 1, in both cases where either of dipropylene glycol monomethyl ether and butyl triglycol was applied as the pretreatment liquid (Disclosure Examples 1 and 2), resulting lines were uniform in line width, and the use of the pretreatment liquid led to an increase in the surface tension (wetting tension) of the printing medium.

Meanwhile, in a case where no pretreatment liquid was applied (Comparative Example 1) and a case where water was applied as the pretreatment liquid (Comparative Example 2), resulting lines were nonuniform in line width. Furthermore, in Comparative Example 2 in which water was applied as the pretreatment liquid, the surface tension (wetting tension) of the printing medium was hardly increased.

These results of Disclosure Examples 1 and 2 and Comparative Examples 1 and 2 have confirmed that, when printing on an OPP film is performed using aqueous ink, as the pretreatment liquid, either of dipropylene glycol monomethyl ether and butyl triglycol is applied to the OPP film, while an excess thereof is wiped off therefrom, and thus it is possible to effectively suppress repelling or feathering of ink droplets.

The present disclosure is usable in an inkjet recording apparatus that ejects ink onto a recording medium. Through the use of the present disclosure, it is possible to provide an inkjet recording apparatus capable of suppressing repelling or feathering of ink in a case of performing image formation using aqueous ink and also of reducing an amount of time required to dry a pretreatment liquid.

What is claimed is:

1. An inkjet recording apparatus, comprising:
a conveyance portion that conveys a recording medium;
a recording portion including a recording head that ejects aqueous ink onto the recording medium conveyed thereto by the conveyance portion; and
an application portion that is arranged upstream of the recording portion in a conveyance direction of the recording medium and applies a pretreatment liquid to the recording medium while wiping off an excess of the pretreatment liquid therefrom,
wherein
the pretreatment liquid is a polyhydric alcohol having 4 to 6 carbon atoms or a monoether of the polyhydric alcohol.

2. The inkjet recording apparatus according to claim 1, wherein
the pretreatment liquid is dipropylene glycol or dipropylene glycol monomethyl ether.

3. The inkjet recording apparatus according to claim 1, further comprising:
a control portion that controls application of the pretreatment liquid to the recording medium by the application portion,
wherein when the recording medium has a surface tension of not more than 40 mN/m, the control portion controls the application portion to perform the application of the pretreatment liquid.

4. The inkjet recording apparatus according to claim 1, wherein
the application portion includes:
an application roller that applies the pretreatment liquid to the recording medium while wiping off an excess of the pretreatment liquid therefrom; and
a liquid supply mechanism that supplies the pretreatment liquid to the application roller.

5. The inkjet recording apparatus according to claim 4, wherein
the application roller includes:
a roller body including an elastic layer provided on an outer circumferential surface thereof; and
a fiber layer covering a surface of the elastic layer, and
the application roller rotates at a linear speed equal to a conveyance speed of the recording medium.

6. The inkjet recording apparatus according to claim 1, wherein
the application portion includes:
a fabric feed-out roller that feeds a fabric impregnated with the pretreatment liquid;
a pressing member that applies the pretreatment liquid to a surface of the recording medium by pressing the fabric fed from the fabric feed-out roller against the recording medium while wiping off an excess of the pretreatment liquid therefrom; and
a fabric winding roller that winds the fabric after the fabric has been pressed against the recording medium by the pressing member.

7. The inkjet recording apparatus according to claim 1, wherein
the recording medium is a plastic film.
